(19) United States
(12) Patent Application Publication
(10) Pub. No.: US 2006/0062875 A1
(43) Pub. Date: Mar. 23, 2006

(54) Preservation of dried vegetable quality in packeted petfood

(76) Inventor: Angeline Gopal, Bathurst (AU)

Correspondence Address: FULBRIGHT & JAWORSKI, LLP, 1301 MCKINNEY, SUITE 5100, HOUSTON, TX, 77010-3095, US

(21) Appl. No.: 10/525,357

(22) PCT Filed: Aug. 22, 2003
(86) PCT No.: PCT/AU03/01071

§ 371 Date: Sep. 30, 2005

(30) Foreign Application Priority Data
Aug. 29, 2002 (AU) 2002951128

(51) Int. Cl. A23B 7/148

(52) U.S. Cl. 426/106

(57) ABSTRACT

A method of preparing vegetable matter for inclusion in commercial packeted pet food, which includes the steps of: treating the vegetable material with sodium metabisulfite; dehydrating the vegetable matter, such that its relative water activity will be lower than about 0.40; coating the treated vegetable matter with humectant material; wherein said humectant material is selected from a group consisting of: a mixture of sorbitol, glucose and glycerol; a mixture of vegetable oil, glucose and glycerol; animal tallow.

### CROSS-REFERENCE TO RELATED APPLICATIONS

This application is a national stage filing of PCT/AU2003/001071 filed Aug. 22, 2003 claiming priority to AU 2002951128 filed Aug. 23, 2002.

### TECHNICAL FIELD

The invention relates to the field of commercial pet food manufacture. In particular it relates to the treatment of vegetables that are intended to be components in a packeted pet food in order to prevent subsequent degradation of vegetable quality and appearance.

### BACKGROUND OF THE INVENTION

A long-standing objective in the design of pet foods is to provide products that have components that are strongly reminiscent of human food. One particular objective is to include high-quality dehydrated vegetable material for its ‘healthy’ nutritional image and for its visual appeal, i.e. for the variety in shape and color it adds to the product as a whole. Such vegetable material is typically blended with cereal- and meat-based products and packaged in relatively moisture-resistant bags for distribution and sale.

There are two particular challenges that are presented by including such materials in a packeted pet food. Firstly, the cereal- and meat-based kibbles, that tend to provide the bulk of such products, tend to have slightly higher moisture levels than the dehydrated vegetables. This leads, over time in intimate contact, to moisture migration from those kibbles into the vegetables. This in turn leads to discoloration of the vegetable materials via oxidation and other mechanisms, with resultant loss of visual appeal and saleability.

Secondly, pet mammals (typically felines and canines) tend not to find vegetable matter, especially when dehydrated, particularly intrinsically palatable. This may lead to the vegetable material being left behind in the pet's food bowl, which does not tend to be received favorably by the pet owner.

Therefore, there is a need to provide a treatment for vegetables, prior to inclusion in the pet food blend, that will both assist in preventing discoloration of the vegetables and will render them relatively more palatable to the animal.

Treatment of dried vegetable matter with a ‘color-fixing’ agent such as sodium metabisulfite is known in the art to help preserve natural color over time, especially where oxidation is the main cause of discoloration. However, simple treatment such as this will not be sufficient to overcome the added challenge of preserving color and texture where the dried vegetable matter is included in a packet with commercial pet food kibbles.

In such cases, it is thought to be beneficial to coat the vegetable pieces with a barrier material or humectant that will prevent the ingress of moisture, oxygen and other harmful compounds.

U.S. Pat. Document No. 4,832,969, by Lioutas, lists a number of such compounds that may be used particularly for dried vegetables for human consumption. This document strongly recommends the use of “low sweetness” sugars such as maltose, presumably as humans do not tend to like vegetables to taste sweet or ‘sugary’. However, it is known that pet mammals do not always respond to the same flavor profiles as humans. In particular it may be suspected that one of the reasons that many pet mammals do not respond as well to the flavor profiles of vegetables as do humans, is due to this kind of divergence with human preferences. Therefore, treatments that work well in a human food context will not necessarily be suitable for pet mammal foods.

Therefore, it is an object of the present invention to provide vegetable material for inclusion in a packeted pet food product that is relatively resistant to the degradation to which such material is normally subjected in such packeted pet food products, and which is acceptably palatable to pet mammals.

### BRIEF SUMMARY OF THE INVENTION

According to one aspect of the invention, there is provided a method of preparing vegetable matter for inclusion in commercial packeted pet food, which includes the steps of:
treating the vegetable material with sodium metabisulfite;
dehydrating the vegetable matter, such that its relative water activity is less than about 0.40;
coating the treated vegetable matter with humectant material;
wherein said humectant material is selected from a group consisting of: a mixture of sorbitol, glucose and glycerol; a mixture of vegetable oil, glucose and glycerol; animal tallow.

In this document, where the term ‘relative water activity’ is used, it will be understood by those skilled in the art to refer to the proportion of water molecules present that are available to react, as compared to pure liquid water substance.

Preferably, the humectant is animal tallow, and is added at an amount sufficient to provide between 1% by mass and 10% by mass of the prepared vegetable material, even more preferably between 4% and 8% by mass. The animal tallow, while known to be palatable to pet mammals, has surprisingly been found to act very effectively in preventing discoloration and other deterioration of vegetable matter included in commercial packeted pet food products. Animal tallow has the added advantage of being the most cost effective of the suitable humectants, and is potentially easier to include in pet food formulations, as it is typically already available on-site at the pet food manufacturing facility. Use of animal tallow in this manner is not known in the prior art.

Beef and poultry tallow has been found to be particularly effective in this application.

Alternatively, where the selected humectant material is a mixture of sorbitol, glucose and glycerol, these ingredients are delivered as an aqueous solution of a mixture of all three ingredients combined in a mass ratio of approximately 1:1:1 and is added at an amount sufficient to provide the mixture of sorbitol, glucose and glycerol at between 1% and 10% by mass of the prepared vegetable material, and more preferably between 3% and 5% by mass. The selection of the known humectants sorbitol and glucose in this formulation is especially beneficial in this application, as they are both particularly ‘sweet’ tasting substances, and therefore make the vegetable material significantly more palatable to pet mammals than would be the case for either untreated vegetables or for vegetables treated with other known humectants, such as are recommended in prior art documents such as U.S. Pat. No. 4,832,969, discussed above.

Alternatively, good results, with respect to both preservation of vegetable quality and palatability, may be obtained where the glycerol of the above formulation is replaced with vegetable oil, for example sunflower oil.

In a particularly preferred embodiment, the vegetable matter consists of size-reduced carrots and diced green beans, although many other types of vegetable matter, including peas, pumpkin, cabbage, tuber dehydrates and other vegetables are also suitable. Suitable size-reduction may include dicing.

In another aspect of the invention, there is provided vegetable material prepared in accordance with any of the embodiments of the method described above.

In another aspect of the invention, there is provided a commercial packeted pet food, including vegetable material prepared in accordance with any of the embodiments of the method described above.

Now will be described, by way of a specific, non-limiting example, a preferred embodiment of the invention.

### DETAILED DESCRIPTION OF THE INVENTION

Diced carrots and diced green beans (in a relative proportion of 50:50 by mass) were prepared by a method according to the invention, as outlined below.

After dicing to approximate dimensions of 6 mm×6 mm×6 mm and washing, the vegetables were blanched and then treated with sodium metabisulfite. This may alternatively be performed with or without processing aides such as sodium carbonate or sodium citrate. The treated vegetables were hot air dried to achieve a water activity of below about 0.5, cooled to ambient temperature, inspected and packed.

Some of the vegetables were coated in beef tallow, of the kind typically available from livestock waste rendering plants. This was done by spraying the tallow on to the vegetables at a mass rate of 4% and a temperature of about 60-70° C. Distribution of the tallow on the surface of the vegetables was achieved by tumbling the vegetables as the spray was applied.

Some of the vegetables were coated in a mixture of sorbitol, glucose and glycerol. The composition of the mixture was an aqueous solution of about 3% sorbitol, 3% glucose and 3% glycerol by mass, and the final vegetable product included sorbitol, glucose and glycerol at a combined proportion of about 4%. Application of the mixture to the surfaces of the vegetables was done as per the beef tallow.

The remainder of the vegetable material was not coated with any humectant material.

Each of the treated and untreated vegetable mixes were then individually blended into CESAR® DUO dog food, a premium pet food product marketed by the applicant, consisting of extruded cereal- and meat-based kibbles, and which is typical of the type of packeted pet mammal food product known in the prior art. The addition rate of the vegetable material to the pet food kibbles was about 4% by mass. The blends underwent storage trials and palatability (feeding) tests.

During the storage trial, the treated vegetables were found to suffer no significant loss of quality when stored at 20° C., 37° C. and 45° C. for in excess of 8 weeks. However, the untreated vegetable matter showed the typical signs of deterioration associated with the prior art, primarily the development of brown color and loss of crispness. Therefore, it is expected that the overall shelf life of the product may be increased to 2 years with treated vegetables, as opposed to only 3 months with untreated vegetables. Similar results were achieved with similar treatments using humectant mixtures consisting of sorbitol, glucose and glycerol, and with mixtures consisting of sunflower oil, glucose and glycerol.

In the feeding test, the following products were offered:
Dry pet food kibble, as per CESAR® DUO, with untreated vegetable blend inclusion, as described above (Diet A);
Dry pet food kibble, as per CESAR® DUO, with beef tallow treated vegetable blend inclusion, as described above (Diet B); and
Dry pet food kibble, as per CESAR® DUO, with vegetable blend inclusion treated with glycerol/glucose/sorbitol, as described above (Diet C).

The diets were fed to a panel of dogs under controlled conditions. Briefly, the feeding protocol was as follows: a Relative Acceptance Test (RAT) was performed, based on a panel of small and toy dogs. Dogs were fed 150 g per day.

Three measures were used to determine the relative palatability of the three diets:
Amount eaten (g): Mean of the amount of the product offered that was eaten in a single meal occasion;
% Ate All: The percentage of meals where all of the product that was offered was eaten; and
Enthusiasm: Mean score (on a scale of 1 to 100) of the owner's perception of the animal's enjoyment of the meal, where a higher score means the animal appeared to enjoy the meal more, and appeared to consume the meal more rapidly.

The results of the feeding test are given in Table 1. P-values given are based on a 95% confidence level.

TABLE 1

| Attribute | Diet A | Diet B | Diet C | p-value |
|---|---|---|---|---|
| Amount Eaten (g) | 63b | 71a | 69a | 0.013 |
| Ate All (%) | 10b | 16a | 12ab | 0.062 |
| Enthusiasm | 55b | 60a | 60a | 0.384 |
| (scale 1-100) | | | | |

The results underwent statistical analysis via an ANOVA model with post hoc comparison. The results from the above table indicate that Diets B and C achieved significantly higher acceptance by the animal than that the diet including untreated carrots and beans.

1. A method of preparing vegetable matter for inclusion in commercial packeted pet food, which includes the steps of:
treating the vegetable material with sodium metabisulfite;
dehydrating the vegetable matter, such that its relative water activity is lower than about 0.40;
coating the treated vegetable matter with humectant material;
wherein said humectant material is selected from a group consisting of: a mixture of sorbitol, glucose and glycerol; a mixture of vegetable oil, glucose and glycerol; animal tallow.

2. The method of claim 1, wherein the humectant is animal tallow.

3. The method of claim 2, wherein said animal tallow is added to said vegetable matter at a rate sufficient to make up between 1% by mass and 10% by mass of said coated vegetable material.

4. The method of claim 3, wherein said animal tallow is added to said vegetable matter at a rate sufficient to make up between 4% by mass and 8% by mass of said coated vegetable material.

5. The method of claim 1, wherein the animal tallow is derived from beef and/or from poultry.

6. The method of claim 1, wherein said humectant material comprises a mixture of sorbitol, glucose and glycerol.

7. The method of claim 6, wherein the relative proportion of sorbitol, glucose and glycerol in said mixture is approximately 1:1:1.

8. The method of claim 7, wherein the mixture of sorbitol, glucose and glycerol is added to said vegetable matter at a rate sufficient to make up between 1% and 10% by mass of said coated vegetable material.

9. The method of claim 8, wherein the mixture of sorbitol, glucose and glycerol is added to said vegetable matter at a rate sufficient to make up between 3% and 5% by mass of said coated vegetable material.

10. The method of claim 1, wherein said humectant material comprises a mixture of sorbitol, glucose and vegetable oil.

11. The method of claim 10, wherein the relative proportion of sorbitol, glucose and vegetable oil in said mixture is approximately 1:1:1.

12. The method of claim 11, wherein the mixture of sorbitol, glucose and vegetable oil is added to said vegetable matter at a rate sufficient to make up between 1% and 10% by mass of said coated vegetable material.

13. The method of claim 12, wherein the mixture of sorbitol, glucose and vegetable oil is added to said vegetable matter at a rate sufficient to make up between 3% and 5% by mass of said coated vegetable material.

14. The method of claim 10, wherein said vegetable oil is sunflower oil.

15. The method of claim 1, wherein said vegetable matter consists of one or more items selected from the group comprising carrots, green beans, peas, pumpkin, cabbage, and tubers.

16. The method of claim 15, wherein said vegetable matter is a blend of diced carrots and diced green beans.

17. Vegetable matter, for inclusion in a commercial packeted pet food, prepared via a method comprising the steps of:
treating vegetable material with sodium metabisulfite;
dehydrating the vegetable matter, such that its relative water activity is lower than about 0.40;
coating the treated vegetable matter with humectant material, said humectant material is selected from a group consisting of: a mixture of sorbitol, glucose and glycerol; a mixture of vegetable oil, glucose and glycerol; animal tallow
wherein the vegetable matter is produced for inclusion in a commercial packeted pet food.

18. A commercial packeted pet food, including vegetable matter prepared via a method comprising the steps of:
treating the vegetable material with sodium metabisulfite;
dehydrating the vegetable matter, such that its relative water activity is lower than about 0.40;
coating the treated vegetable matter with humectant material, said humectant material is selected from a group consisting of: a mixture of sorbitol, glucose and glycerol; a mixture of vegetable oil, glucose and glycerol; animal tallow;
wherein a commercial packeted pet food that includes vegetable matter is produced.
